(19) United States
(12) Patent Application Publication
(10) Pub. No.: US 2007/0235266 A1
(43) Pub. Date: Oct. 11, 2007

(54) Low profile lift

(76) Inventors: Roy Dantas, Toronto (CA); Jack Nobre, Brampton (CA); Kyle Smith, Toronto (CA)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/369,650

(22) Filed: Mar. 7, 2006

(51) Int. Cl. B66B 9/02

(52) U.S. Cl. 187/269

(57) ABSTRACT

A lifting device having a base, a platform, scissor means operably connected to said base and platform removing said platform from a lowered position to a raised position, drive means for moving said scissor means and lever means operably connected to said drive means and said scissor means for moving said platform between said lowered position and raised position.

### FIELD OF INVENTION

This invention relates to a lifting device having a low profile and particularly relates to a device for lifting a vehicle with a platform which has a low profile in the lowered position. The invention also relates to a method of lowering the profile of a platform supporting a vehicle on a scissor lift supported on a surface.

### BACKGROUND OF THE INVENTION

Various devices have heretofore been designed in order to lift vehicles above the ground in order to service same. Such lifting devices include scissor type lifting mechanisms which generally include a base or base frame and a platform which supports the vehicle as well as a scissor mechanism for moving the platform between a raised and lowered position.

It is desirable that when the scissor type lifting platform is in the lowered or down position the platform be as low as possible in order to facilitate the positioning of the load to be lifted. In particular lifting platforms for vehicles should project as little as possible above the floor surface or base in order to facilitate the driving of the vehicles onto the platforms. Generally speaking driving mechanisms such as hydraulic cylinders or the like are utilized to move the scissor mechanisms from a lowered to a raised position.

Although it is desirable to make the platform as low profile as possible, it should also be pointed out that the driving mechanism such as a hydraulic cylinder will generally require more force to lift the platform at least in the initial lowered stage the closer that the platform is to the base or supporting floor surface. In other words as the hydraulic cylinder approaches a horizontal angle, greater force is required to push or lift the platform relative to the base.

Various devices have heretofore been designed to attempt to meet the features referred to above. For example, U.S. Pat. No. 6,464,205 relates to a scissor type lifting platform which utilizes expansion levers during the swivelling position of the scissor spars, where the expansion lever rolls away from the lowest position on one or more rotatable supporting roller bodies.

Another device is disclosed in U.S. Pat. No. 5,192,053 which relates to a device for initiating a lifting movement in a lifting mechanism by utilizing a double armed lever connected to a first lifting arm as particularized therein.

Furthermore, another arrangement is shown in U.S. Pat. No. 2,899,172 which relates to an elevating mechanism for truck bodies which utilizes a cam member pivoted intermediate it ends in a roller journal led on the chassis frame.

Other arrangements can be found in the following German patents, DE89 15 859.8, DE 91 04 900.7, DE 93 02 967.5 and DE 196 13 341.6.

It is an object of this invention to provide an improved mechanism for scissor type lifts having a low profile. It is another object of this invention to provide an improved method for lowering the profile of scissor lifts.

It is an aspect of this invention to provide a lifting device having a base, a platform, and a scissor structure operably connected to the base and platform for moving the platform from a lowered position to a raised position, and a drive for moving the scissor structure, and a lever arm operably connected to the drive and the scissor structure for moving the platform between said lowered and raised positions.

It is another aspect of this invention to provide a device for lifting a vehicle comprising: a base; a platform for supporting the vehicle; first and second spaced scissor arms operably connected to the base and platform for moving the platform from, a first lowered position to, a second intermediate position, and a raised position; a drive for moving the scissor arms; a rotatable arm operably connected to the drive and the first pair of scissor arms for moving the platform between the first lowered position and second intermediate position; and a bearing surface carried by the first pair of spaced scissor arms for contacting the rotatable arm between the second intermediate position and the raised position.

It is another aspect of this invention to provide a method of lowering the profile of a platform supporting a vehicle in a scissor lift supported on a surface comprising: activating a drive so as to move an arm pivotally connected to a scissor structure from a first lowered position to a second intermediate position where the arm bears against a stop plate carried by the scissor mechanism, and thereby raise the platform; continuing to move the scissor structure to the raised position; de-activating said drive so as to move the platform from the raised position to the intermediate position with said arm contacting said stop plate; continuing to de-activate the drive so as to move the platform from the intermediate position to the lowered position when the arm rotates away from the stop plate and contacts the surface.

### DESCRIPTION OF THE DRAWINGS

These and other objects of the features of the invention shall now be described in relation to the following drawings.

FIG. 1 is a side elevational view of the scissor lift in the lowered position.

FIG. 2 is a side elevational view of the scissor lift in an intermediate position showing the lowered position in phantom lines.

FIG. 3 is a side elevational view of the scissor lift in the raised position.

FIG. 4 is a perspective view of the scissor lift in the intermediate position.

FIG. 5 is a partial perspective view of the scissor lift of FIG. 4 with the stop plate removed to better show the mechanism.

### DETAILED DESCRIPTION OF THE INVENTION

Like parts will be given like numbers throughout the figures. Furthermore the drawings are not necessarily to scale.

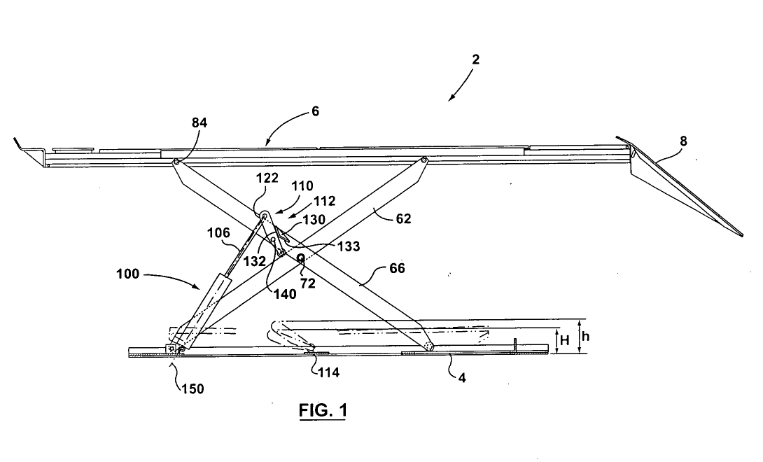

FIG. 1 generally illustrates a lifting device 2 which includes a base 4, platform 6 and a ramp 8. In particular the base 4 can comprise a base frame 10 having a pair of spaced substantially parallel angle iron sides 12 and 14 that are connected together by members 16 and 18. Furthermore member 20 is also connected to sides 12 and 14. In particular member 20 defines and presents a bearing surface 22 for contacting rollers 40 in a manner to be described below. Alternatively, surface 22 could be removed and the rollers 116 contact a surface 24 which supports the lift 2. For example, the surface 24 can comprise of a concrete floor or the like. However, it is preferred to use the bearing surface 22 to increase the wear characteristics as the rollers 116 exert a large force.

Generally speaking the base 4 or base frame 10 can comprise of metal which is either welded together or connected by fasteners in a manner well known to those persons skilled in the art.

The platform 6 is adapted to support a vehicle (not shown) or the like when the lift 2 is in the lowered or bottom position. In the lowered position, the ramp 8 contacts a surface 24 causing the ramp 8 to pivot counter clockwise and provide a smooth surface for a vehicle to ride against when moving on the platform 6 in a manner well known to those persons skilled in the art.

The device 2 also includes scissor means 60 which is operably connected to the base 6 or base frame 10 and platform 6 for moving the platform 6 from a lowered position as shown in FIG. 3 to a raised position as shown in FIG. 1.

In particular the scissor means 60 comprises a first pair of spaced apart scissor arms 62 and 64 which are rotationally or pivotally connected to a second pair of spaced apart scissor arms 66 and 68 at pivot pins 70 and 72 as shown in the drawings.

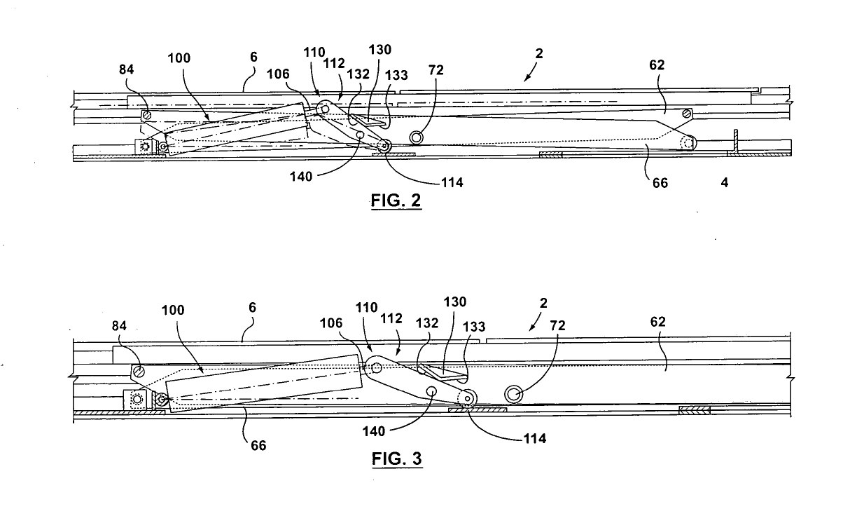

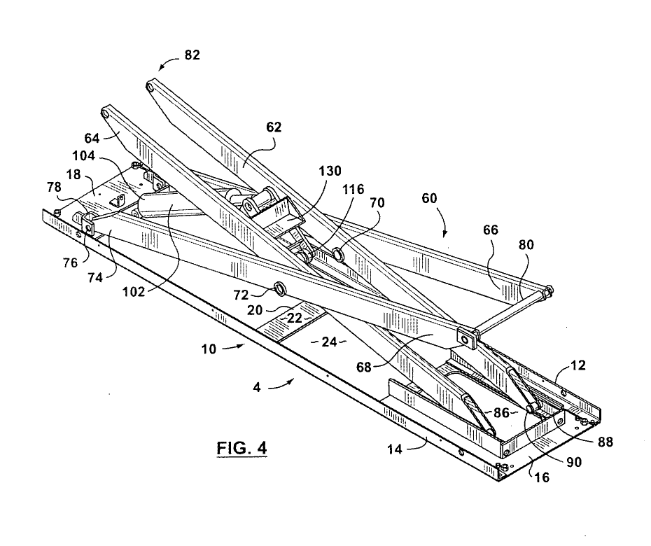

One end 74 of each of the second pair of spaced apart arms 66 and 68 are connected to the base 4 by means of pins 76 fastened to a bracket 78 that are carried by the member 18 as shown in FIG. 4. Accordingly one end 74 of the second pair of spaced apart scissor arms 66 and 68 are connected to the base for pivotal or rotational movement about the pin 76. Another end 80 of the second pair of spaced apart scissor arms 66 and 68 slide relative to the platform 6 during movement of the platform 6 from the first lowered position shown in FIG. 3, second intermediate position shown in FIG. 2 and the raised position shown in FIG. 1.

Moreover one end 82 of the first pair of spaced apart arms 62 and 64 are connected to the platform by means of pins 84 in a manner well known to those persons skilled in the art for pivotal or rotational movement thereabouts while another end 86 of the first pair of spaced apart scissor arms 62 and 64 slide relative to the base 4 or base frame 10 during movement of the platform 6 from the first lowered position shown in FIG. 3, second intermediate position shown in FIG. 2 and raised position shown in FIG. 1. In particular, the base 4 includes guide blocks 88 for guiding rollers 90 for slideable relative movement therealong.

A drive means 100 is utilized for moving the scissor means 60 from the lowered position shown in FIG. 3 to the raised position shown in FIG. 1.

The drive means 100 can comprise of a number of structures including a hydraulic cylinder 102 which has one end 104 connected to the base 4 or the member 18 of the base frame 10 as shown in FIG. 4. The hydraulic cylinder 102 can include a piston or ram 106 at another end of the hydraulic cylinder as shown.

The device 2 also includes a lever means 110 which is operably connected to the drive means 100 and scissor means 60 for moving the platform 6 between a lowered position shown in FIG. 3 and the raised position shown in FIG. 1.

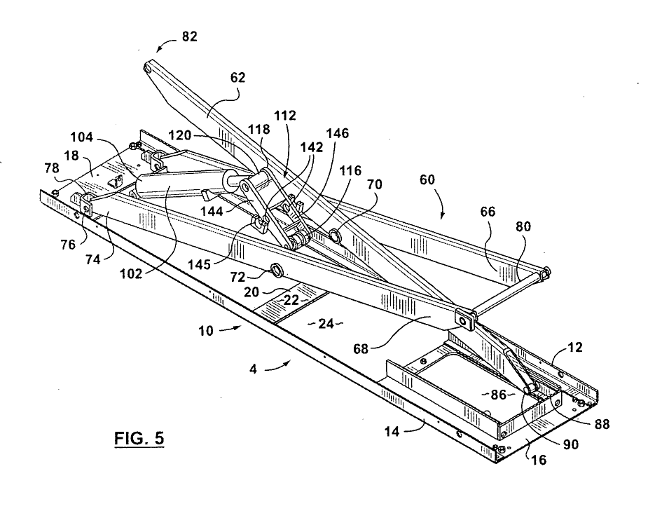

In one embodiment the lever means 110 comprises an arm assembly 112 which is more fully particularized in FIG. 5. The arm assembly 112 includes on end 114 for engaging the base 4 as shown in FIG. 3. In particular, the one end 114 includes rollers 116 for contacting the base 4. More specifically the rollers 116 contact surface 22 of member 20 in a manner to be more fully described below. Alternatively, the rollers 116 can contact a surface 24 such as a concrete floor or the like.

Another end 118 of the arm assembly 112 is operably connected to the drive means 120. In particular the other end 118 of the arm assembly 112 includes a rotatable shaft 120 which is connected to one end 122 of the piston 106 as shown in FIG. 1.

The scissor means 60 includes a stop plate 130. The stop plate 130 as shown comprises of a V-shape although any shape of stop plate 130 can be utilized in accordance with the invention described herein. The stop plate 130 defines a bearing surface 132 for contacting the arm assembly 112 when the lift 2 is moved between the second intermediate position shown in FIG. 2 and the raised position shown in FIG. 1 in a manner to be described herein.

Accordingly the operation of the invention shall now be described in relation to FIGS. 3, 2 and 1. In the lower most position shown in FIG. 3, the rollers 116 contact the base surface 22 and the piston 106 is retracted within the hydraulic cylinder 100 whereby the arm assembly 112 is disengaged from the bearing surface 132 of the stop plate 130 as shown.

As the hydraulic cylinder is activated by any number of means well known to those persons skilled in the art the piston 106 is pushed outwardly so as to cause the arm assembly as shown in FIG. 3 to rotate in a clockwise manner about pin 140. In particular pin 140 is adapted to be received by apertures 142 presented by two spaced apart arms 144 and 146. Furthermore the first pair of spaced apart scissor arms 66 and 68 includes a pin receiver which is connected thereto by welding means or the like so as to fixedly retain the pin 140. The pin receivers 146 can be welded to the first pair of spaced apart scissor arms 66 and 68 or otherwise connected. The pin 140 is fixedly retained therein so as to permit the arm assembly 112 to pivot or rotate thereabouts. Moreover the stop plate 130 is also connected to the first part of spaced apart scissor arms 66 and 68 by welding or the like as shown, which prevents the pins 140 from dislodging.

Accordingly as the piston 106 pushes against the other end 118 of the arm assembly 112 the arm assembly 112 rotates clockwise as previously described about pin 140 which causes the rollers 116 to ride along the base surface 22 and “lift” the platform from the lowermost height H in the lowered position shown in FIG. 3 to an intermediate position h as shown in FIG. 2. At the intermediate position shown in FIG. 2 the arm assembly 112 contacts the bearing surface 132 of stop plate 130 as shown. Further movement of the piston 106 will thereby transfer force through the lever arm assembly 112 to the stop plate 130 and therefore the first pair of spaced apart scissor arms 66 and 68 so as to move the platform 6 from the intermediate position shown in FIG. 2 to the raised position in shown in FIG. 3. During movement of the platform 6 from the intermediate position shown in FIG. 2 to the raised position shown in FIG. 1 the rollers 116 will disengage from the surface 122.

During deactivation or lowering of the platform 6 from FIG. 1 the arm assembly 112 will continue to contact the bearing surface 132 of the stop plate 130 from the raised position to the intermediate position shown in FIG. 2.

Upon further deactivation of the hydraulic cylinder 100, the piston 106 will continue to pull the end 118 of the arm assembly 112 counter clockwise so as to enable the platform 6 to be lowered from the intermediate position to the lowered position. This permits the hydraulic cylinder 102 to move into a more horizontal position nestled between the base 4 and platform 6 thereby permitting lowering of the profile of the lift 2. FIG. 1 shows that the arm assembly 112 will rotate counter clockwise until the arm assembly 112 contacts limit surface 133 of top plate 130.

In one embodiment the angle of the center line 150 of the hydraulic cylinder 102 was disposed at approximately 12° from the horizontal in the intermediate position shown in FIG. 2; which represents the disposition of the hydraulic cylinder 102 if the arm assembly 112 and stop plate 130 were not utilized. At this position the height h of the platform 6 to the surface 24 was approximately 11¼ inches.

However, upon utilization of the arm assembly 112 and stop plate 130 as previously described the hydraulic cylinder 100 is able to further retract the piston 106 so as to cause the lever arm assembly 112 to rotate to the lowered position shown in FIG. 3 thereby lowering the profile of the platform 6 relative to the base 4. In one embodiment the angle from the center line 150 to the horizontal was reduced to approximately 7¼ which represented a height H in the lowered position of approximately just under 9 inches.

Moreover, by utilizing the invention as described herein, the hydraulic cylinder can more easily lift the platform 6 from the lowest position to the intermediate position, thereby improving the mechanical advantage.

Accordingly the invention described herein also relates to a method of lowering the profile of a platform 6 supporting a vehicle (not shown) on a scissor lift 2 mounted on a surface 24 comprising:
(a) activating a hydraulic drive 100 so as to move an arm assembly 112 pivotally connected to a scissor means 60 from a first lowered position to a second intermediate position where the arm assembly bears against a stop plate 130 carried by the scissor means 60 and thereby raise the platform;
(b) continuing to move the scissor means 60 to the raised position;
(c) deactivating the hydraulic cylinder 100 so as to move the platform 6 from the raised position to an intermediate position with the arm assembly contacting the stop plate;
(d) continuing to deactivate the hydraulic cylinder 100 so as to move the platform from the intermediate position to the lowered position where the arm assembly rotates away from the stop plate 130 and contacts the surface 22.

The method described herein illustrates that the arm assembly rotates in a first counter clockwise direction when the platform 6 moves from the intermediate position to the lowered position. Furthermore the arm assembly 112 rotates in a second clockwise position when the platform moves from the lowered position to the intermediate position.

The foregoing is a description of the preferred embodiments of the invention which is given here by way of example only. The invention is not to be taken as limited to any one of the specific features as described, but comprehends all such variations thereof as come within the scope of the appended claims.

1. A lifting device having:
(a) A base;
(b) a platform;
(c) scissor means operably connected to said base and platform for moving said platform from a lowered position to a raised position;
(d) drive means for moving said scissor means,
(c) lever means operably connected to said drive means and said scissor means for moving said platform between said lowered position and a base; raised position, said lever means having one end disposed below said scissor means in said lowered position.

2. A lifting device as claimed in claim 6 wherein said lever means comprises an arm assembly rotatable about said scissor means, between said pivot point and an end of said first and second pair of scissor arms.

3. A lifting device as claimed in claim 2 wherein said arm assembly includes one end for engaging said base and another end operably connected to said drive means.

4. A lifting device as claimed in claim 3 wherein said scissor means includes a stop plate for engaging said arm assembly when said drive means moves said platform from said lowered position to said raised position.

5. A lifting device as claimed in claim 4 wherein said drive means comprises a hydraulic cylinder operably connected to said arm assembly, and said base is disposed below said scissor means.

6. A lifting device as claimed in claim 2 wherein said scissor means comprises a first pair of spaced scissor arms pivotally connected to a second pair of spaced scissors arms, about a pivot point.

7. A lifting device as claimed in claim 6 wherein said arm assembly is pivotally connected to said first pair of spaced scissor arms for pivotal movement thereabouts.

8. A lifting device as claimed in claim 7 wherein said stop plate is connected between said first pair of spaced scissor arms.

9. A lifting device as claimed in claim 8 wherein said arm assembly contacts said stop plate in said raised position.

10. A device for lifting a vehicle comprising:
(a) a base;
(b) a platform for supporting said vehicle;
(c) first and second spaced scissor arms operably connected to said base and platform for moving said platform from:
(i) a first lowered position,
(ii) a second intermediate position;
(iii) a raised position;
(d) cylinder means for moving said scissor arms;
(e) arm means operably connected to said cylinder means and said first pair of scissor arms for moving said platform between said first lowered position, and said second intermediate position;
(f) a bearing surface carried by said first pair of spaced scissor arms for contacting said arm means between said second intermediate position and said raised position;
(g) said arm means rotates about said bearing surface between said first lowered portion and said second intermediate portion.

11. A device as claimed in claim 10 wherein said arm means includes one end for engaging said base between said first lowered position and said second intermediate position.

12. A device as claimed in claim 11 wherein said arm means disengages said base between said second intermediate position and said raised position.

13. A device as claimed in claim 12 wherein said arm means comprises a pair of spaced apart arms having rollers at one end for contacting said base.

14. A device as claimed in claim 13 wherein said arms include another end operably connected to said cylinder means.

15. A device as claimed in claim 14 further including a pivot pin connected between said first pair of spaced apart scissor arms and wherein said pair of spaced apart arms pivot about said pin intermediate said ends.

16. A device as claimed in claim 15 wherein one end of said second pair of spaced apart scissor arms are connected to said base for pivotal movement thereabout, and another end of said second pair of spaced apart scissor arms slide relative to said platform during movement of said platform from said first lowered position, second intermediate position and said raised position.

17. A device as claimed in claim 16 wherein in one end of said first pair of spaced apart scissor arms are connected to said platform for pivotal movement thereabouts, and another end of said first pair of spaced apart scissor arms slide relative to said base during movement of said platform from said first lowered position, second intermediate position and said raised position.

18. A method of lowering the profile of a platform supporting a vehicle on a scissor lift mounted on a surface comprising:
(a) activating a drive so as to move an arm pivotally connected to a scissor means from a first lowered position to a second intermediate position where said arm bears against a stop plate carried by said scissor means and thereby raise said drive and platform, said arm rotating about said stop plate between said first lowered position and said second intermediate position;
(b) continuing to move said scissor means to said raised position;
(c) deactivating said drive so as to move said platform from said raised position to said intermediate position with said arm contacting said stop plate;
(d) continuing to deactivate said drive so as to move said platform from said intermediate position to said lowered position where said arm rotates away from said stop plate and contacts said surface.

19. A method as claimed in claim 18 wherein said arm rotates in a first direction when said platform moves from said intermediate position to said lowered position.

20. A method as claimed in claim 19 wherein said arm rotates in a second direction when said platform moved from said lowered position to said intermediate position.
